(19) United States
(12) Patent Application Publication
(10) Pub. No.: US 2022/0101381 A1
(43) Pub. Date: Mar. 31, 2022

(54) System For Capturing And Analyzing First Party Data Of A User For Use On An Autonomous Vehicle Advertising Or Content Platform

(71) Applicant: Alexander Terzian, Boston, MA (US)

(72) Inventor: Alexander Terzian, Boston, MA (US)

(21) Appl. No.: 17/547,005

(22) Filed: Dec. 9, 2021

Related U.S. Application Data
(63) Continuation-in-part of application No. 15/613,190, filed on Jun. 3, 2017, now Pat. No. 10,331,122.
Application No. 15/613,190 is a continuation-in-part of application No. 15/897,788, filed on Feb. 15, 2018.
(60) Provisional application No. 62/484,947, filed on Apr. 13, 2017.

(51) Int. Cl. G06Q 30/02; G05D 1/00; G05D 1/02; G08G 1/00; G06V 20/56; H04W 4/40

(52) U.S. Cl. CPC G06Q 30/0266; G06Q 30/0271; G06Q 30/0261; G06Q 30/0246; H04W 4/40; G05D 1/0246; G08G 1/20; G06V 20/56; G05D 1/0027

(57) ABSTRACT

A system for capturing and analyzing first-party data of a user. The user's first party data is received from a mobile software application and a self-driving vehicle equipped with digital content screens and intelligent sensors for capturing data. The data source shared between the vehicle and the software application would be owned by the same provider. Privacy concerns surrounding user data would be minimal because the provider would have exact sources for the data and approved usage rights directly from the user. The user first-party data will give the provider improved insights into that consumer's interests and needs, allowing the provider to provide digital content to the user personalized digital content on the digital content screens of the self-driving vehicle. The data collected from the user in or near the self-driving vehicle may be used to target the user on the provider websites, social media, or the mobile software application.

### CROSS REFERENCE TO RELATED APPLICATION

This application claims the benefit of U.S. Provisional Patent Application No. 62/484,947, filed on Apr. 13, 2017, and is a continuation-in-part of U.S. patent application Ser. No. 15/613,190, filed Jun. 3, 2017, and is a continuation-in-part of application Ser. No. 15/897,788, filed Feb. 15, 2018, the contents of which are all incorporated herein by reference.

### FIELD OF THE INVENTION

The invention relates to a system for capturing and analyzing user first-party data to display direct contact digital content on self-driving vehicles displaying external digital content platforms, and further capturing and analyzing additional user first-party data from the self-driving vehicles.

### BACKGROUND OF INVENTION

Evaluating the effectiveness of digital content and marketing strategies and tactics can difficult and costly to obtain. Such evaluation is needed to formulate and implement these strategies and tactics to reach the maximum number of targeted customers, and potential customers, for the minimal amount of expenses. Without constant re-evaluation and control of digital content and marketing strategies, they can lose effectiveness or costs can spiral out of control.

Traditional digital content outlets, such as billboards, printed media (e.g. newspapers, magazines, direct marketing mailers), radio, and television commercials reach broad untargeted audiences, but they suffer from several evaluation and assessment problems: 1) it is difficult to calculate the number of views to specific targeted individuals or groups of individuals; 2) these types of digital content are costly to produce; 3) these types of digital content result in overpayment due to a lack of targeting, resulting in a waste of digital content expenditures; and 4) these types of advertisement are difficult to modify quickly to reach an audience that changes in real time.

Newer forms of digital content strategies and tactics on electronic media such as website digital content, mobile device digital content, social media, and e-mail are much easier to track views, less costly to produce, easier to limit to targeted individuals or groups of individuals, and can be modified quickly to reach different audiences in real time. However, these types of media do not reach broad audiences, and often fail to reach customers or potential customers at the edge, or outside of a targeted group.

So, the subject invention is a new tool for evaluating digital content that is cheaper to produce, easy to modify in real time based on audience evaluation, can be tailored to reach specific individuals or groups of individuals, and can reach broad audiences.

The subject invention discloses a system for capturing and analyzing first-party data of a user. The user's first party data is received from a consumer oriented mobile software application and a self-driving vehicle equipped with digital content screens and intelligent sensors for capturing data. The data source shared between the self-driving vehicle digital content screens and the mobile software application would be owned by the same provider, making the data source first-party. Due to shared ownership, privacy concerns surrounding user first party data would be minimal because the provider would have exact sources for the data and approved usage rights directly from the user. The user first-party data will give the provider improved insights into that consumer's interests and needs, allowing the provider to provide digital content to the user personalized digital content on the digital content screens of the self-driving vehicle. First party user data collected from the self-driving vehicle digital content screens may also be used to target the user cross platform. The data collected from the user in or near the self-driving vehicle may be used to target the user on the provider websites, social media applications, or the mobile software application.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a system for capturing and analyzing first party data of a user for use on an autonomous vehicle digital content platform, the system comprising: a self-driving vehicle containing a computing processor comprising executable software, wherein the processor is communicatively coupled with a data storage device; a first plurality of sensors for capturing data from and monitoring the surrounding environment of the self-driving vehicle, wherein the first plurality of sensors is communicatively coupled with the computing processor and the data storage device; a second plurality of sensors for capturing data from and monitoring the internal drive systems of the self-driving vehicle, wherein the second plurality of sensors is communicatively coupled with the computing processor and the data storage device; wherein the data captured from the first and second plurality of sensors is received by the computing processor, the executable software controls the driving functions of the self-driving vehicle; an external video screen for displaying a plurality of digital content, wherein the external video screen is communicatively coupled with the computing processor and the data storage device; a plurality of intelligent camera sensors for taking images and video along a particular field-of-view around and external to the self-driving vehicle, wherein the plurality of intelligent camera sensors is communicatively coupled with the computing processor and the data storage device; a mobile software application for download and use on a mobile device by the user, wherein the user orders the self-driving vehicle with the mobile software application, further wherein the mobile software application communicates first party data of the user to the self-driving vehicle; wherein the computing processor and the executable software calculates which digital content from the plurality of digital content to display on the external video screen based on the first party data of the user, wherein the computing processor and the executable software generates a plurality of digital content impressions from the plurality of digital content once the self-driving vehicle is proximate to the user.

The subject invention also discloses a system for capturing and analyzing first party data of a user for use on an autonomous road vehicle digital content platform, the system comprising: a self-driving road vehicle containing a computing processor comprising executable software, wherein the processor is communicatively coupled with a data storage device; a first plurality of sensors for capturing data from and monitoring the surrounding environment of the self-driving road vehicle, wherein the first plurality of sensors is communicatively coupled with the computing processor and the data storage device; a second plurality of sensors for capturing data from and monitoring the internal drive systems of the self-driving road vehicle, wherein the second plurality of sensors is communicatively coupled with the computing processor and the data storage device; wherein the data captured from the first and second plurality of sensors is received by the computing processor, the executable software controls the driving functions of the self-driving road vehicle; an external video screen for displaying a plurality of digital content, wherein the external video screen is communicatively coupled with the computing processor and the data storage device; a plurality of intelligent camera sensors for taking images and video along a particular field-of-view around and external to the self-driving road vehicle, wherein the plurality of intelligent camera sensors is communicatively coupled with the computing processor and the data storage device; a mobile software application for download and use on a mobile device by the user, wherein the user orders the self-driving road vehicle with the mobile software application, further wherein the mobile software application communicates first party data of the user to the self-driving road vehicle; wherein the computing processor and the executable software calculates which digital content from the plurality of digital content to display on the external video screen based on the first party data of the user, wherein the computing processor and the executable software generates a plurality of digital content impressions from the plurality of digital content once the self-driving road vehicle is proximate to the user.

The subject invention further discloses a system for capturing and analyzing first party data of a user for use on an autonomous air vehicle digital content platform, the system comprising: a self-driving air vehicle containing a computing processor comprising executable software, wherein the processor is communicatively coupled with a data storage device; a first plurality of sensors for capturing data from and monitoring the surrounding environment of the self-driving air vehicle, wherein the first plurality of sensors is communicatively coupled with the computing processor and the data storage device; a second plurality of sensors for capturing data from and monitoring the internal drive systems of the self-driving air vehicle, wherein the second plurality of sensors is communicatively coupled with the computing processor and the data storage device; wherein the data captured from the first and second plurality of sensors is received by the computing processor, the executable software controls the driving functions of the self-driving air vehicle; an external video screen for displaying a plurality of digital content, wherein the external video screen is communicatively coupled with the computing processor and the data storage device; a plurality of intelligent camera sensors for taking images and video along a particular field-of-view around and external to the self-driving air vehicle, wherein the plurality of intelligent camera sensors is communicatively coupled with the computing processor and the data storage device; a mobile software application for download and use on a mobile device by the user, wherein the user orders the self-driving air vehicle with the mobile software application, further wherein the mobile software application communicates first party data of the user to the self-driving air vehicle; wherein the computing processor and the executable software calculates which digital content from the plurality of digital content to display on the external video screen based on the first party data of the user, wherein the computing processor and the executable software generates a plurality of digital content impressions from the plurality of digital content once the self-driving air vehicle is proximate to the user.

The subject invention discloses a system for capturing and analyzing first party data of a user for use on an autonomous watercraft digital content platform, the system comprising: a self-navigating watercraft containing a computing processor comprising executable software, wherein the processor is communicatively coupled with a data storage device; a first plurality of sensors for capturing data from and monitoring the surrounding environment of the self-navigating watercraft, wherein the first plurality of sensors is communicatively coupled with the computing processor and the data storage device; a second plurality of sensors for capturing data from and monitoring the internal drive systems of the self-navigating watercraft, wherein the second plurality of sensors is communicatively coupled with the computing processor and the data storage device; wherein the data captured from the first and second plurality of sensors is received by the computing processor, the executable software controls the driving functions of the self-navigating watercraft; an external video screen for displaying a plurality of digital content, wherein the external video screen is communicatively coupled with the computing processor and the data storage device; a plurality of intelligent camera sensors for taking images and video along a particular field-of-view around and external to the self-navigating watercraft, wherein the plurality of intelligent camera sensors is communicatively coupled with the computing processor and the data storage device; a mobile software application for download and use on a mobile device by the user, wherein the user orders the self-navigating watercraft with the mobile software application, further wherein the mobile software application communicates first party data of the user to the self-navigating watercraft; wherein the computing processor and the executable software calculates which digital content from the plurality of digital content to display on the external video screen based on the first party data of the user, wherein the computing processor and the executable software generates a plurality of digital content impressions from the plurality of digital content once the self-navigating watercraft is proximate to the user.

The subject invention also discloses a system for capturing and analyzing first party data of a user for use on an autonomous aerial drone digital content platform, the system comprising: a self-driving aerial drone containing a computing processor comprising executable software, wherein the processor is communicatively coupled with a data storage device; a first plurality of sensors for capturing data from and monitoring the surrounding environment of the self-driving aerial drone, wherein the first plurality of sensors is communicatively coupled with the computing processor and the data storage device; a second plurality of sensors for capturing data from and monitoring the internal drive systems of the self-driving aerial drone, wherein the second plurality of sensors is communicatively coupled with the computing processor and the data storage device; wherein the data captured from the first and second plurality of sensors is received by the computing processor, the executable software controls the driving functions of the self-driving aerial drone; an external video screen for displaying a plurality of digital content, wherein the external video screen is communicatively coupled with the computing processor and the data storage device; a plurality of intelligent camera sensors for taking images and video along a particular field-of-view around and external to the self-driving aerial drone, wherein the plurality of intelligent camera sensors is communicatively coupled with the computing processor and the data storage device; a mobile software application for download and use on a mobile device by the user, wherein the user orders the self-driving aerial drone with the mobile software application, further wherein the mobile software application communicates first party data of the user to the self-driving aerial drone; wherein the computing processor and the executable software calculates which digital content from the plurality of digital content to display on the external video screen based on the first party data of the user, wherein the computing processor and the executable software generates a plurality of digital content impressions from the plurality of digital content once the self-driving aerial drone is proximate to the user.

The subject invention discloses a method for capturing and analyzing first party data of a user for use on an autonomous vehicle digital content platform, comprising the steps of: (a) downloading a mobile software application on a mobile device by the user; (b) collecting first party data of the user on the mobile device through the mobile software application; (c) ordering a self-driving vehicle with the mobile software application, wherein the mobile software application communicates first party data of the user to the self-driving vehicle; (d) calculating the route from the self-driving vehicle to the user; (e) generating instructions for the self-driving vehicle to follow directions to the user, wherein the self driving vehicle comprises a computing processor comprising executable software for receiving said instructions, wherein the processor is communicatively coupled with a data storage device; (f) capturing data from and monitoring the surrounding environment of the self-driving vehicle as it progresses to the user from a first plurality of sensors, wherein the first plurality of sensors is communicatively coupled with the computing processor and the data storage device; (g) capturing data from and monitoring the internal drive systems of the self-driving vehicle as it progresses towards the user from a second plurality of sensors, wherein the second plurality of sensors is communicatively coupled with the computing processor and the data storage device; (h) controlling the driving functions of the self-driving vehicle with the data captured from the first and second plurality of sensors received by the computing processor; (i) displaying a plurality of digital content on an external video screen, wherein the external video screen is communicatively coupled with the computing processor and the data storage device; (j) capturing radiation reflected from objects along a particular field-of-view around and external to the self-driving vehicle with a plurality of intelligent radiation sensors, wherein the plurality of intelligent radiation sensors is communicatively coupled with the computing processor and the data storage device; (k) identifying the user from the reflected radiation in the particular field-of-view around and external to the self-driving vehicle from the data captured from the plurality of intelligent radiation sensors on the computing processor; (l) calculating which digital content from the plurality of digital content to display on the external video screen based on the first party data of the user; and (m) generating a plurality of digital content impressions from the plurality of digital content once the self-driving vehicle is proximate to the user.

The subject invention also discloses a method for capturing and analyzing first party data of a user for use on an autonomous road vehicle digital content platform, comprising the steps of: (a) downloading a mobile software application on a mobile device by the user; (b) collecting first party data of the user on the mobile device through the mobile software application; (c) ordering a self-driving road vehicle with the mobile software application, wherein the mobile software application communicates first party data of the user to the self-driving road vehicle; (d) calculating the route from the self-driving road vehicle to the user; (e) generating instructions for the self-driving road vehicle to follow directions to the user, wherein the self driving road vehicle comprises a computing processor comprising executable software for receiving said instructions, wherein the processor is communicatively coupled with a data storage device; (f) capturing data from and monitoring the surrounding environment of the self-driving road vehicle as it progresses to the user from a first plurality of sensors, wherein the first plurality of sensors is communicatively coupled with the computing processor and the data storage device; (g) capturing data from and monitoring the internal drive systems of the self-driving road vehicle as it progresses towards the user from a second plurality of sensors, wherein the second plurality of sensors is communicatively coupled with the computing processor and the data storage device; (h) controlling the driving functions of the self-driving road vehicle with the data captured from the first and second plurality of sensors received by the computing processor; (i) displaying a plurality of digital content on an external video screen, wherein the external video screen is communicatively coupled with the computing processor and the data storage device; (j) capturing radiation reflected from objects along a particular field-of-view around and external to the self-driving road vehicle with a plurality of intelligent radiation sensors, wherein the plurality of intelligent radiation sensors is communicatively coupled with the computing processor and the data storage device; (k) identifying the user from the reflected radiation in the particular field-of-view around and external to the self-driving road vehicle from the data captured from the plurality of intelligent radiation sensors on the computing processor; (l) calculating which digital content from the plurality of digital content to display on the external video screen based on the first party data of the user; and (m) generating a plurality of digital content impressions from the plurality of digital content once the self-driving road vehicle is proximate to the user.

The subject invention additionally discloses a method for capturing and analyzing first party data of a user for use on an autonomous air vehicle digital content platform, comprising the steps of: (a) downloading a mobile software application on a mobile device by the user; (b) collecting first party data of the user on the mobile device through the mobile software application; (c) ordering a self-driving air vehicle with the mobile software application, wherein the mobile software application communicates first party data of the user to the self-driving air vehicle; (d) calculating the route from the self-driving air vehicle to the user; (e) generating instructions for the self-driving air vehicle to follow directions to the user, wherein the self driving air vehicle comprises a computing processor comprising executable software for receiving said instructions, wherein the processor is communicatively coupled with a data storage device; (f) capturing data from and monitoring the surrounding environment of the self-driving air vehicle as it progresses to the user from a first plurality of sensors, wherein the first plurality of sensors is communicatively coupled with the computing processor and the data storage device; (g) capturing data from and monitoring the internal drive systems of the self-driving air vehicle as it progresses towards the user from a second plurality of sensors, wherein the second plurality of sensors is communicatively coupled with the computing processor and the data storage device; (h) controlling the driving functions of the self-driving air vehicle with the data captured from the first and second plurality of sensors received by the computing processor; (i) displaying a plurality of digital content on an external video screen, wherein the external video screen is communicatively coupled with the computing processor and the data storage device; (j) capturing radiation reflected from objects along a particular field-of-view around and external to the self-driving air vehicle with a plurality of intelligent radiation sensors, wherein the plurality of intelligent radiation sensors is communicatively coupled with the computing processor and the data storage device; (k) identifying the user from the reflected radiation in the particular field-of-view around and external to the self-driving air vehicle from the data captured from the plurality of intelligent radiation sensors on the computing processor; (l) calculating which digital content from the plurality of digital content to display on the external video screen based on the first party data of the user; and (m) generating a plurality of digital content impressions from the plurality of digital content once the self-driving air vehicle is proximate to the user.

The subject invention discloses a method for capturing and analyzing first party data of a user for use on an autonomous watercraft digital content platform, comprising the steps of: (a) downloading a mobile software application on a mobile device by the user; (b) collecting first party data of the user on the mobile device through the mobile software application; (c) ordering a self-navigating watercraft with the mobile software application, wherein the mobile software application communicates first party data of the user to the self-navigating watercraft; (d) calculating the route from the self-navigating watercraft to the user; (e) generating instructions for the self-navigating watercraft to follow directions to the user, wherein the self driving watercraft comprises a computing processor comprising executable software for receiving said instructions, wherein the processor is communicatively coupled with a data storage device; (f) capturing data from and monitoring the surrounding environment of the self-navigating watercraft as it progresses to the user from a first plurality of sensors, wherein the first plurality of sensors is communicatively coupled with the computing processor and the data storage device; (g) capturing data from and monitoring the internal drive systems of the self-navigating watercraft as it progresses towards the user from a second plurality of sensors, wherein the second plurality of sensors is communicatively coupled with the computing processor and the data storage device; (h) controlling the driving functions of the self-navigating watercraft with the data captured from the first and second plurality of sensors received by the computing processor; (i) displaying a plurality of digital content on an external video screen, wherein the external video screen is communicatively coupled with the computing processor and the data storage device; (j) capturing radiation reflected from objects along a particular field-of-view around and external to the self-navigating watercraft with a plurality of intelligent radiation sensors, wherein the plurality of intelligent radiation sensors is communicatively coupled with the computing processor and the data storage device; (k) identifying the user from the reflected radiation in the particular field-of-view around and external to the self-navigating watercraft from the data captured from the plurality of intelligent radiation sensors on the computing processor; (l) calculating which digital content from the plurality of digital content to display on the external video screen based on the first party data of the user; and (m) generating a plurality of digital content impressions from the plurality of digital content once the self-navigating watercraft is proximate to the user.

The subject invention also discloses a method for capturing and analyzing first party data of a user for use on an autonomous aerial drone digital content platform, comprising the steps of: (a) downloading a mobile software application on a mobile device by the user; (b) collecting first party data of the user on the mobile device through the mobile software application; (c) ordering a self-driving aerial drone with the mobile software application, wherein the mobile software application communicates first party data of the user to the self-driving aerial drone; (d) calculating the route from the self-driving aerial drone to the user; (e) generating instructions for the self-driving aerial drone to follow directions to the user, wherein the self driving aerial drone comprises a computing processor comprising executable software for receiving said instructions, wherein the processor is communicatively coupled with a data storage device; (f) capturing data from and monitoring the surrounding environment of the self-driving aerial drone as it progresses to the user from a first plurality of sensors, wherein the first plurality of sensors is communicatively coupled with the computing processor and the data storage device; (g) capturing data from and monitoring the internal drive systems of the self-driving aerial drone as it progresses towards the user from a second plurality of sensors, wherein the second plurality of sensors is communicatively coupled with the computing processor and the data storage device; (h) controlling the driving functions of the self-driving aerial drone with the data captured from the first and second plurality of sensors received by the computing processor; (i) displaying a plurality of digital content on an external video screen, wherein the external video screen is communicatively coupled with the computing processor and the data storage device; (j) capturing radiation reflected from objects along a particular field-of-view around and external to the self-driving aerial drone with a plurality of intelligent radiation sensors, wherein the plurality of intelligent radiation sensors is communicatively coupled with the computing processor and the data storage device; (k) identifying the user from the reflected radiation in the particular field-of-view around and external to the self-driving aerial drone from the data captured from the plurality of intelligent radiation sensors on the computing processor; (l) calculating which digital content from the plurality of digital content to display on the external video screen based on the first party data of the user; and (m) generating a plurality of digital content impressions from the plurality of digital content once the self-driving aerial drone is proximate to the user.

The subject invention discloses an intelligent sensor system for capturing digital content impressions on an autonomous vehicle digital content platform comprising: a self-driving road vehicle containing a computing processor comprising executable software, wherein the processor is communicatively coupled with a data storage device; a first plurality of sensors for capturing data from and monitoring the surrounding environment of the self-driving road vehicle, wherein the first plurality of sensors is communicatively coupled with the computing processor and the data storage device; a second plurality of sensors for capturing data from and monitoring the internal drive systems of the self-driving road vehicle, wherein the second plurality of sensors is communicatively coupled with the computing processor and the data storage device; wherein the data captured from the first and second plurality of sensors is received by the computing processor, the executable software controls the driving functions of the self-driving road vehicle; an external video screen for displaying a plurality of digital content, wherein the external video screen is communicatively coupled with the computing processor and the data storage device; a plurality of intelligent radiation sensors responsive to radiation reflected from objects along a particular field-of-view around and external to the self-driving road vehicle, wherein the plurality of intelligent radiation sensors is communicatively coupled with the computing processor and the data storage device; wherein the data captured from the plurality of intelligent radiation sensors is received by the computing processor, and the executable software comprises human recognition software and vehicle recognition software to identify a plurality of individuals and a plurality of vehicles from the reflected radiation in the particular field-of-view around and external to the self-driving road vehicle in real-time; wherein the computing processor and the executable software calculates which digital content from the plurality of digital content shown on the external video screen were visible to the identified plurality of individuals and plurality of vehicles based on the time and location of each advertisement in relation to each individual and vehicle, wherein the computing processor and the executable software generates a plurality of digital content impressions of the plurality of digital content.

The subject invention discloses an method for capturing digital content impressions on an autonomous vehicle digital content platform comprising: generating instructions for a self-driving road vehicle to drive down a plurality of roads, wherein the self driving road vehicle comprises a computing processor comprising executable software for receiving said instructions, wherein the processor is communicatively coupled with a data storage device; capturing data from and monitoring the surrounding environment of the self-driving road vehicle as it drives down the plurality of roads from a first plurality of sensors, wherein the first plurality of sensors is communicatively coupled with the computing processor and the data storage device; capturing data from and monitoring the internal drive systems of the self-driving road vehicle as it drives down the plurality of roads from a second plurality of sensors, wherein the second plurality of sensors is communicatively coupled with the computing processor and the data storage device; controlling the driving functions of the self-driving road vehicle with the data captured from the first and second plurality of sensors received by the computing processor; displaying a plurality of digital content on an external video screen, wherein the external video screen is communicatively coupled with the computing processor and the data storage device; capturing radiation reflected from objects along a particular field-of-view around and external to the self-driving road vehicle with a plurality of intelligent radiation sensors, wherein the plurality of intelligent radiation sensors is communicatively coupled with the computing processor and the data storage device; identifying a plurality of individuals and a plurality of vehicles from the reflected radiation in the particular field-of-view around and external to the self-driving road vehicle from the data captured from the plurality of intelligent radiation sensors using human recognition software and vehicle recognition software on the computing processor; calculating which digital content from the plurality of digital content shown on the external video screen were visible to the identified plurality of individuals and plurality of vehicles based on the time and location of each advertisement in relation to each individual and vehicle; and generating a plurality of digital content impressions of the plurality of digital content.

The subject invention discloses an intelligent sensor system for capturing digital content impressions on an autonomous vehicle digital content platform comprising: a self-driving road vehicle containing a computing processor comprising executable software, wherein the processor is communicatively coupled with a data storage device; a first plurality of sensors for capturing data from and monitoring the surrounding environment of the self-driving road vehicle, wherein the first plurality of sensors is communicatively coupled with the computing processor and the data storage device; a second plurality of sensors for capturing data from and monitoring the internal drive systems of the self-driving road vehicle, wherein the second plurality of sensors is communicatively coupled with the computing processor and the data storage device; wherein the data captured from the first and second plurality of sensors is received by the computing processor, the executable software controls the driving functions of the self-driving vehicle; an external video screen for displaying a plurality of digital content, wherein the external video screen is communicatively coupled with the computing processor and the data storage device; a plurality of intelligent camera sensors for taking images and video along a particular field-of-view around and external to the self-driving vehicle, wherein the plurality of intelligent camera sensors is communicatively coupled with the computing processor and the data storage device; wherein the data captured from the plurality of intelligent camera sensors is received by the computing processor, and the executable software comprises human recognition software and vehicle recognition software to identify a plurality of individuals and a plurality of vehicles in the particular field-of-view around and external to the self-driving vehicle in real-time; wherein the computing processor and the executable software calculates which digital content from the plurality of digital content shown on the external video screen were visible to the identified plurality of individuals and plurality of vehicles based on the time and location of each advertisement in relation to each individual and vehicle, wherein the computing processor and the executable software generates a plurality of digital content impressions of the plurality of digital content.

The subject invention also discloses an intelligent sensor system for capturing digital content impressions on an autonomous vehicle digital content platform comprising: a self-driving road vehicle containing a computing processor comprising executable software, wherein the processor is communicatively coupled with a data storage device; a first plurality of sensors for capturing data from and monitoring the surrounding environment of the self-driving road vehicle, wherein the first plurality of sensors is communicatively coupled with the computing processor and the data storage device; a second plurality of sensors for capturing data from and monitoring the internal drive systems of the self-driving road vehicle, wherein the second plurality of sensors is communicatively coupled with the computing processor and the data storage device; wherein the data captured from the first and second plurality of sensors is received by the computing processor, the executable software controls the driving functions of the self-driving vehicle; an external video screen for displaying a plurality of digital content, wherein the external video screen is communicatively coupled with the computing processor and the data storage device; a plurality of intelligent radiation sensors responsive to radiation reflected from objects along a particular field-of-view around and external to the self-driving vehicle, wherein the plurality of intelligent radiation sensors is communicatively coupled with the computing processor and the data storage device; wherein the data captured from the plurality of intelligent radiation sensors is received by the computing processor, and the executable software comprises human recognition software and vehicle recognition software to identify a plurality of individuals and a plurality of vehicles from the reflected radiation in the particular field-of-view around and external to the self-driving vehicle in real-time; wherein the computing processor and the executable software calculates which digital content from the plurality of digital content shown on the external video screen were visible to the identified plurality of individuals and plurality of vehicles based on the time and location of each advertisement in relation to each individual and vehicle, wherein the computing processor and the executable software generates a plurality of digital content impressions of the plurality of digital content.

In further embodiments of the subject invention, the invention comprises a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling a plurality of self-driving vehicles and external video screens in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring the generated plurality of digital content impressions in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring generated pluralities of digital content impressions from a plurality of self-driving road vehicles in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time, wherein the control server software can configure the digital content displayed on the external video screen in real-time based on the geographic location of the self-driving vehicle.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; wherein the control server comprises executable software for tracking and monitoring the generated plurality of digital content impressions in real time; and further wherein the control server software analyses the digital content impressions to generate optimal routes for the self-driving vehicle.

In further embodiments of the subject invention, the self-driving vehicle can be a land wheeled vehicle selected from the group consisting of: carts, all-terrain vehicles, cars, trucks, platform trucks, flatbed trucks, semi-trailer trucks, buses, minivans, cargo vans, and panel vans.

In further embodiments of the subject invention, the self-driving vehicle can be an aerial drone.

The subject invention also discloses a method for capturing digital content impressions on an autonomous vehicle digital content platform comprising: generating instructions for a self-driving road vehicle to drive down a plurality of roads, wherein the self driving vehicle comprises a computing processor comprising executable software for receiving said instructions, wherein the processor is communicatively coupled with a data storage device; capturing data from and monitoring the surrounding environment of the self-driving road vehicle as it drives down the plurality of roads from a first plurality of sensors, wherein the first plurality of sensors is communicatively coupled with the computing processor and the data storage device; capturing data from and monitoring the internal drive systems of the self-driving road vehicle as it drives down the plurality of roads from a second plurality of sensors, wherein the second plurality of sensors is communicatively coupled with the computing processor and the data storage device; controlling the driving functions of the self-driving vehicle with the data captured from the first and second plurality of sensors received by the computing processor; displaying a plurality of digital content on an external video screen, wherein the external video screen is communicatively coupled with the computing processor and the data storage device; capturing radiation reflected from objects along a particular field-of-view around and external to the self-driving vehicle with a plurality of intelligent radiation sensors, wherein the plurality of intelligent radiation sensors is communicatively coupled with the computing processor and the data storage device; identifying a plurality of individuals and a plurality of vehicles from the reflected radiation in the particular field-of-view around and external to the self-driving vehicle from the data captured from the plurality of intelligent radiation sensors using human recognition software and vehicle recognition software on the computing processor; calculating which digital content from the plurality of digital content shown on the external video screen were visible to the identified plurality of individuals and plurality of vehicles based on the time and location of each advertisement in relation to each individual and vehicle; and generating a plurality of digital content impressions of the plurality of digital content.

In further embodiments of the subject invention, the method comprises sending and receiving data files between a communication circuitry in the self-driving vehicle and a remote control server; and controlling the self-driving vehicle and the external video screen in real time with the remote control server.

In further embodiments of the subject invention, the method comprises sending and receiving data files between a communication circuitry in the self-driving vehicle and a remote control server; and controlling a plurality of self-driving vehicles and external video screens in separate geographic locations in real time with the remote control server.

In further embodiments of the subject invention, the method comprises sending and receiving data files between a communication circuitry in the self-driving vehicle and a remote control server; and tracking the generated plurality of digital content impressions in real time with the remote control server.

In further embodiments of the subject invention, the method comprises sending and receiving data files between a communication circuitry in the self-driving vehicle and a remote control server; and generated pluralities of digital content impressions from a plurality of self-driving road vehicles in separate geographic locations in real time with the remote control server.

In further embodiments of the subject invention, the method comprises sending and receiving data files between a communication circuitry in the self-driving vehicle and a remote control server; controlling the self-driving vehicle and the external video screen in real time with the remote control server; and configuring the digital content displayed on the external video screen in real-time based on the geographic location of the self-driving vehicle with the control server.

In further embodiments of the subject invention, the method comprises sending and receiving data files between a communication circuitry in the self-driving vehicle and a remote control server; and tracking the generated plurality of digital content impressions in real time with the remote control server, and analyzing the plurality digital content impressions to generate optimal routes for the self-driving vehicle.

The subject invention discloses an intelligent sensor system for capturing digital content impressions on an autonomous aerial drone digital content platform comprising: a self-flying aerial drone containing a computing processor comprising executable software, wherein the processor is communicatively coupled with a data storage device; a first plurality of sensors for capturing data from and monitoring the surrounding environment of the self-flying aerial drone, wherein the first plurality of sensors is communicatively coupled with the computing processor and the data storage device; a second plurality of sensors for capturing data from and monitoring the internal drive systems of the self-flying aerial drone, wherein the second plurality of sensors is communicatively coupled with the computing processor and the data storage device; wherein the data captured from the first and second plurality of sensors is received by the computing processor, the executable software controls the driving functions of the self-flying aerial drone; an external video screen for displaying a plurality of digital content, wherein the external video screen is communicatively coupled with the computing processor and the data storage device; a plurality of intelligent camera sensors for taking images and video along a particular field-of-view around and external to the self-flying aerial drone, wherein the plurality of intelligent camera sensors is communicatively coupled with the computing processor and the data storage device; wherein the data captured from the plurality of intelligent camera sensors is received by the computing processor, and the executable software comprises human recognition software and aerial drone recognition software to identify a plurality of individuals and a plurality of aerial drones in the particular field-of-view around and external to the self-flying aerial drone in real-time; wherein the computing processor and the executable software calculates which digital content from the plurality of digital content shown on the external video screen were visible to the identified plurality of individuals and plurality of aerial drones based on the time and location of each advertisement in relation to each individual and aerial drone, wherein the computing processor and the executable software generates a plurality of digital content impressions of the plurality of digital content.

The subject invention also discloses an intelligent sensor system for capturing digital content impressions on an autonomous aerial drone digital content platform comprising: a self-flying aerial drone containing a computing processor comprising executable software, wherein the processor is communicatively coupled with a data storage device; a first plurality of sensors for capturing data from and monitoring the surrounding environment of the self-flying aerial drone, wherein the first plurality of sensors is communicatively coupled with the computing processor and the data storage device; a second plurality of sensors for capturing data from and monitoring the internal drive systems of the self-flying aerial drone, wherein the second plurality of sensors is communicatively coupled with the computing processor and the data storage device; wherein the data captured from the first and second plurality of sensors is received by the computing processor, the executable software controls the driving functions of the self-flying aerial drone; an external video screen for displaying a plurality of digital content, wherein the external video screen is communicatively coupled with the computing processor and the data storage device; a plurality of intelligent radiation sensors responsive to radiation reflected from objects along a particular field-of-view around and external to the self-flying aerial drone, wherein the plurality of intelligent radiation sensors is communicatively coupled with the computing processor and the data storage device; wherein the data captured from the plurality of intelligent radiation sensors is received by the computing processor, and the executable software comprises human recognition software and aerial drone recognition software to identify a plurality of individuals and a plurality of aerial drones from the reflected radiation in the particular field-of-view around and external to the self-flying aerial drone in real-time; wherein the computing processor and the executable software calculates which digital content from the plurality of digital content shown on the external video screen were visible to the identified plurality of individuals and plurality of aerial drones based on the time and location of each advertisement in relation to each individual and aerial drone, wherein the computing processor and the executable software generates a plurality of digital content impressions of the plurality of digital content.

In further embodiments of the subject invention, the invention comprises a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking, monitoring, and controlling the self-flying aerial drones and the external video screen in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking, monitoring, and controlling a plurality of self-flying aerial drones and external video screens in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking and monitoring the generated plurality of digital content impressions in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking and monitoring generated pluralities of digital content impressions from a plurality of self-flying aerial drones in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking, monitoring, and controlling the self-flying aerial drones and the external video screen in real time, wherein the control server software can configure the digital content displayed on the external video screen in real-time based on the geographic location of the self-flying aerial drone.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; wherein the control server comprises executable software for tracking and monitoring the generated plurality of digital content impressions in real time; and further wherein the control server software analyses the digital content impressions to generate optimal routes for the self-flying aerial drone.

The subject invention also discloses a method for capturing digital content impressions on an autonomous aerial drone digital content platform comprising: generating instructions for a self-flying aerial drone to fly, wherein the self driving aerial drone comprises a computing processor comprising executable software for receiving said instructions, wherein the processor is communicatively coupled with a data storage device; capturing data from and monitoring the surrounding environment of the self-flying aerial drone as it flies from a first plurality of sensors, wherein the first plurality of sensors is communicatively coupled with the computing processor and the data storage device; capturing data from and monitoring the internal drive systems of the self-flying aerial drone as it flies from a second plurality of sensors, wherein the second plurality of sensors is communicatively coupled with the computing processor and the data storage device; controlling the driving functions of the self-flying aerial drone with the data captured from the first and second plurality of sensors received by the computing processor; displaying a plurality of digital content on an external video screen, wherein the external video screen is communicatively coupled with the computing processor and the data storage device; capturing radiation reflected from objects along a particular field-of-view around and external to the self-flying aerial drone with a plurality of intelligent radiation sensors, wherein the plurality of intelligent radiation sensors is communicatively coupled with the computing processor and the data storage device; identifying a plurality of individuals and a plurality of aerial drones from the reflected radiation in the particular field-of-view around and external to the self-flying aerial drone from the data captured from the plurality of intelligent radiation sensors using human recognition software and aerial drone recognition software on the computing processor; calculating which digital content from the plurality of digital content shown on the external video screen were visible to the identified plurality of individuals and plurality of aerial drones based on the time and location of each advertisement in relation to each individual and aerial drone; and generating a plurality of digital content impressions of the plurality of digital content.

In further embodiments of the subject invention, the method comprises sending and receiving data files between a communication circuitry in the self-flying aerial drone and a remote control server; and controlling the self-flying aerial drone and the external video screen in real time with the remote control server.

In further embodiments of the subject invention, the method comprises sending and receiving data files between a communication circuitry in the self-flying aerial drone and a remote control server; and controlling a plurality of self-flying aerial drones and external video screens in separate geographic locations in real time with the remote control server.

In further embodiments of the subject invention, the method comprises sending and receiving data files between a communication circuitry in the self-flying aerial drone and a remote control server; and tracking the generated plurality of digital content impressions in real time with the remote control server.

In further embodiments of the subject invention, the method comprises sending and receiving data files between a communication circuitry in the self-flying aerial drone and a remote control server; and generated pluralities of digital content impressions from a plurality of self-flying aerial drones in separate geographic locations in real time with the remote control server.

In further embodiments of the subject invention, the method comprises sending and receiving data files between a communication circuitry in the self-flying aerial drone and a remote control server; controlling the self-flying aerial drone and the external video screen in real time with the remote control server; and configuring the digital content displayed on the external video screen in real-time based on the geographic location of the self-flying aerial drone with the control server.

In further embodiments of the subject invention, the method comprises sending and receiving data files between a communication circuitry in the self-flying aerial drone and a remote control server; and tracking the generated plurality of digital content impressions in real time with the remote control server, and analyzing the plurality digital content impressions to generate optimal routes for the self-flying aerial drone.

The subject invention discloses an intelligent sensor system for capturing digital content impressions on an autonomous watercraft digital content platform comprising: a self-navigating watercraft containing a computing processor comprising executable software, wherein the processor is communicatively coupled with a data storage device; a first plurality of sensors for capturing data from and monitoring the surrounding environment of the self-navigating watercraft, wherein the first plurality of sensors is communicatively coupled with the computing processor and the data storage device; a second plurality of sensors for capturing data from and monitoring the internal drive systems of the self-navigating watercraft, wherein the second plurality of sensors is communicatively coupled with the computing processor and the data storage device; wherein the data captured from the first and second plurality of sensors is received by the computing processor, the executable software controls the driving functions of the self-navigating watercraft; an external video screen for displaying a plurality of digital content, wherein the external video screen is communicatively coupled with the computing processor and the data storage device; a plurality of intelligent camera sensors for taking images and video along a particular field-of-view around and external to the self-navigating watercraft, wherein the plurality of intelligent camera sensors is communicatively coupled with the computing processor and the data storage device; wherein the data captured from the plurality of intelligent camera sensors is received by the computing processor, and the executable software comprises human recognition software and watercraft recognition software to identify a plurality of individuals and a plurality of watercrafts in the particular field-of-view around and external to the self-navigating watercraft in real-time; wherein the computing processor and the executable software calculates which digital content from the plurality of digital content shown on the external video screen were visible to the identified plurality of individuals and plurality of watercrafts based on the time and location of each advertisement in relation to each individual and watercraft, wherein the computing processor and the executable software generates a plurality of digital content impressions of the plurality of digital content.

The subject invention also discloses an intelligent sensor system for capturing digital content impressions on an autonomous watercraft digital content platform comprising: a self-navigating watercraft containing a computing processor comprising executable software, wherein the processor is communicatively coupled with a data storage device; a first plurality of sensors for capturing data from and monitoring the surrounding environment of the self-navigating watercraft, wherein the first plurality of sensors is communicatively coupled with the computing processor and the data storage device; a second plurality of sensors for capturing data from and monitoring the internal drive systems of the self-navigating watercraft, wherein the second plurality of sensors is communicatively coupled with the computing processor and the data storage device; wherein the data captured from the first and second plurality of sensors is received by the computing processor, the executable software controls the driving functions of the self-navigating watercraft; an external video screen for displaying a plurality of digital content, wherein the external video screen is communicatively coupled with the computing processor and the data storage device; a plurality of intelligent radiation sensors responsive to radiation reflected from objects along a particular field-of-view around and external to the self-navigating watercraft, wherein the plurality of intelligent radiation sensors is communicatively coupled with the computing processor and the data storage device; wherein the data captured from the plurality of intelligent radiation sensors is received by the computing processor, and the executable software comprises human recognition software and watercraft recognition software to identify a plurality of individuals and a plurality of watercrafts from the reflected radiation in the particular field-of-view around and external to the self-navigating watercraft in real-time; wherein the computing processor and the executable software calculates which digital content from the plurality of digital content shown on the external video screen were visible to the identified plurality of individuals and plurality of watercrafts based on the time and location of each advertisement in relation to each individual and watercraft, wherein the computing processor and the executable software generates a plurality of digital content impressions of the plurality of digital content.

In further embodiments of the subject invention, the invention comprises a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking, monitoring, and controlling the self-navigating watercrafts and the external video screen in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking, monitoring, and controlling a plurality of self-navigating watercrafts and external video screens in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking and monitoring the generated plurality of digital content impressions in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking and monitoring generated pluralities of digital content impressions from a plurality of self-navigating watercrafts in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking, monitoring, and controlling the self-navigating watercrafts and the external video screen in real time, wherein the control server software can configure the digital content displayed on the external video screen in real-time based on the geographic location of the self-navigating watercraft.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; wherein the control server comprises executable software for tracking and monitoring the generated plurality of digital content impressions in real time; and further wherein the control server software analyses the digital content impressions to generate optimal routes for the self-navigating watercraft.

The subject invention also discloses a method for capturing digital content impressions on an autonomous watercraft digital content platform comprising: generating instructions for a self-navigating watercraft, wherein the self driving watercraft comprises a computing processor comprising executable software for receiving said instructions, wherein the processor is communicatively coupled with a data storage device; capturing data from and monitoring the surrounding environment of the self-navigating watercraft from a first plurality of sensors, wherein the first plurality of sensors is communicatively coupled with the computing processor and the data storage device; capturing data from and monitoring the internal drive systems of the self-navigating watercraft from a second plurality of sensors, wherein the second plurality of sensors is communicatively coupled with the computing processor and the data storage device; controlling the driving functions of the self-navigating watercraft with the data captured from the first and second plurality of sensors received by the computing processor; displaying a plurality of digital content on an external video screen, wherein the external video screen is communicatively coupled with the computing processor and the data storage device; capturing radiation reflected from objects along a particular field-of-view around and external to the self-navigating watercraft with a plurality of intelligent radiation sensors, wherein the plurality of intelligent radiation sensors is communicatively coupled with the computing processor and the data storage device; identifying a plurality of individuals and a plurality of watercrafts from the reflected radiation in the particular field-of-view around and external to the self-navigating watercraft from the data captured from the plurality of intelligent radiation sensors using human recognition software and watercraft recognition software on the computing processor; calculating which digital content from the plurality of digital content shown on the external video screen were visible to the identified plurality of individuals and plurality of watercrafts based on the time and location of each advertisement in relation to each individual and watercraft; and generating a plurality of digital content impressions of the plurality of digital content.

In further embodiments of the subject invention, the method comprises sending and receiving data files between a communication circuitry in the self-navigating watercraft and a remote control server; and controlling the self-navigating watercraft and the external video screen in real time with the remote control server.

In further embodiments of the subject invention, the method comprises sending and receiving data files between a communication circuitry in the self-navigating watercraft and a remote control server; and controlling a plurality of self-navigating watercrafts and external video screens in separate geographic locations in real time with the remote control server.

In further embodiments of the subject invention, the method comprises sending and receiving data files between a communication circuitry in the self-navigating watercraft and a remote control server; and tracking the generated plurality of digital content impressions in real time with the remote control server.

In further embodiments of the subject invention, the method comprises sending and receiving data files between a communication circuitry in the self-navigating watercraft and a remote control server; and generated pluralities of digital content impressions from a plurality of self-navigating watercrafts in separate geographic locations in real time with the remote control server.

In further embodiments of the subject invention, the method comprises sending and receiving data files between a communication circuitry in the self-navigating watercraft and a remote control server; controlling the self-navigating watercraft and the external video screen in real time with the remote control server; and configuring the digital content displayed on the external video screen in real-time based on the geographic location of the self-navigating watercraft with the control server.

In further embodiments of the subject invention, the method comprises sending and receiving data files between a communication circuitry in the self-navigating watercraft and a remote control server; and tracking the generated plurality of digital content impressions in real time with the remote control server, and analyzing the plurality digital content impressions to generate optimal routes for the self-navigating watercraft.

In further embodiments of the subject invention, the control server monitors the location and displayed digital content on the external video screen platform in real-time.

In additional embodiments of the subject invention, control server monitors and controls a plurality of self-driving road vehicle, aerial drone, or watercraft in separate geographic locations.

In other embodiments of the subject invention, the control server software can configure the digital content displayed on the external video screen platform in real-time based on the geographic location of the self-driving vehicle, aerial drone, or water craft.

In embodiments of the subject invention, the control server software can configure the digital content displayed on the external video screen platform in real-time based on the time.

In additional embodiments of the subject invention, the control server software can analysis and configure the digital content displayed on the external video screen platform in real-time to generate optimal routes for the digital content campaign.

In further embodiments of the subject invention, the self-driving vehicle can be any land wheeled vehicle.

In other embodiments of the subject invention, the self-driving vehicle can be an aerial drone.

In further embodiments of the subject invention, the self-driving vehicle can be a land wheeled vehicle selected from the group consisting of: carts, all-terrain vehicles, cars, trucks, platform trucks, flatbed trucks, semi-trailer trucks, buses, minivans, cargo vans, panel vans, utility vehicle, sport utility vehicle, golf cart, bus, minibus, ambulance, school bus, delivery truck, motor home, shuttle bus, fire truck, flatbed truck, trailer, fifth wheel trailer, caravan, armored truck, dump truck, garbage truck and a tractor.

In other embodiments of the subject invention, the self-driving vehicle can be a watercraft, selected from the group consisting of: boats, yachts, ships, Jet-skis®, or other personal watercraft.

In other embodiments of the subject invention, the plurality of cameras comprise human recognition software to analyze captures images of individuals in close proximity to the self-driving vehicle to estimate the audience for a displayed advertisement.

In further embodiments of the subject invention, the plurality of cameras comprise human recognition software to analyze captures images of individuals in close proximity to the self-driving vehicle to alter displayed digital content on the external video screen platform in real time.

In embodiments of the subject invention, the terms “substantial” or “substantially” are defined as at least close to (and can include) a given value or state, as understood by a person of ordinary skill in the art. In one embodiment, the terms “substantial” or “substantially” refers to ranges within 10%, preferably within 5%, more preferably within 1%, and most preferably within 0.1% of the given value or state being specified.

There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates one embodiment of a self-driving truck with a video signage digital content platform on the side of the truck.

FIG. 2 illustrates another embodiment of a self-driving truck with a video signage digital content platform on the top of the truck.

FIG. 3 illustrates one embodiment of a self-driving bus with a video signage digital content platform on the top of the bus.

FIG. 4 illustrates another embodiment of a self-driving bus with a video signage digital content platform on the top of the bus.

FIG. 5 illustrates one embodiment of a self-driving van with a video signage digital content platform on the side of the van.

FIG. 6 illustrates another embodiment of a self-driving van with a video signage digital content platform on the side of the van.

FIG. 7 illustrates another embodiment of a self-driving van with a video signage digital content platform on the top of the van.

FIG. 8 illustrates another embodiment of a self-driving van with a video signage digital content platform on the front of the van.

FIG. 9 illustrates another embodiment of a self-driving van with a video signage digital content platform on the top of the van.

FIG. 10 illustrates another embodiment of a self-driving van with a video signage digital content platform on the rear of the van.

FIG. 11 illustrates an embodiment of a self-driving aerial drone with a video signage digital content platform.

FIG. 12 illustrates an embodiment of a diagram of a self-driving vehicle capturing images of individuals around the vehicle.

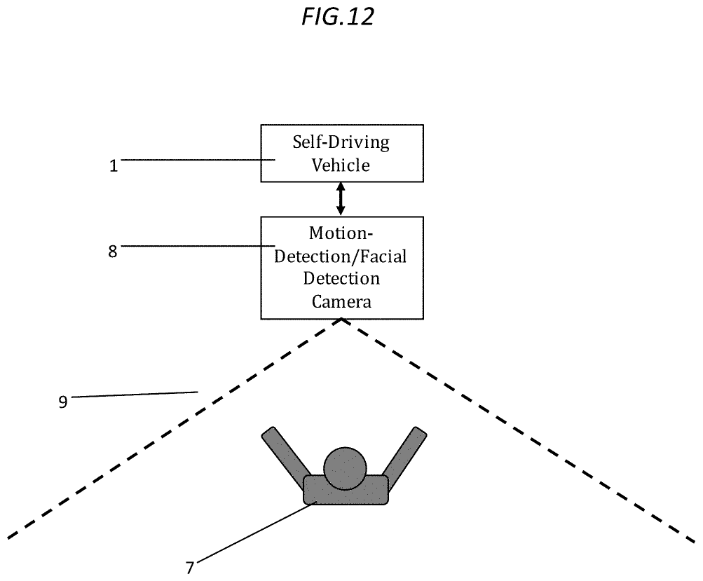

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

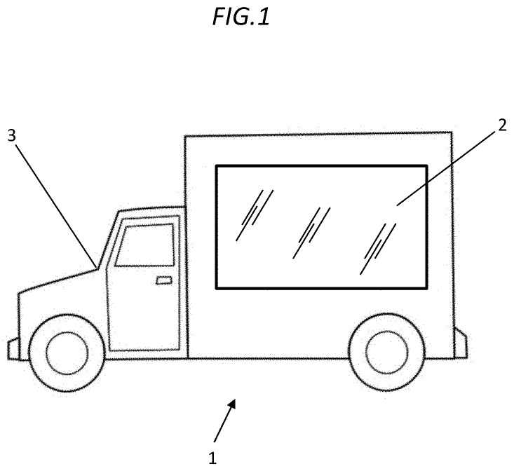

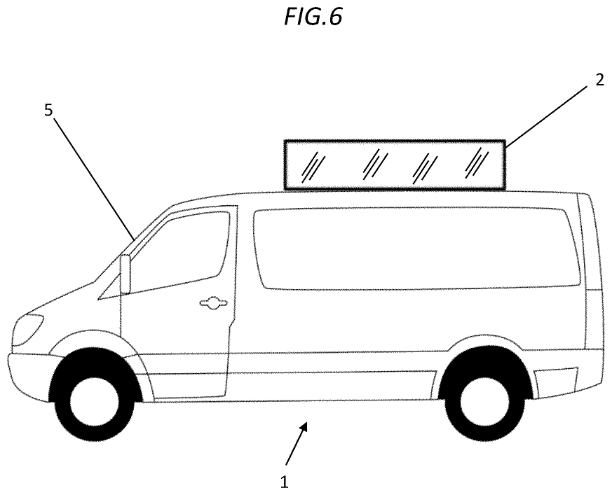

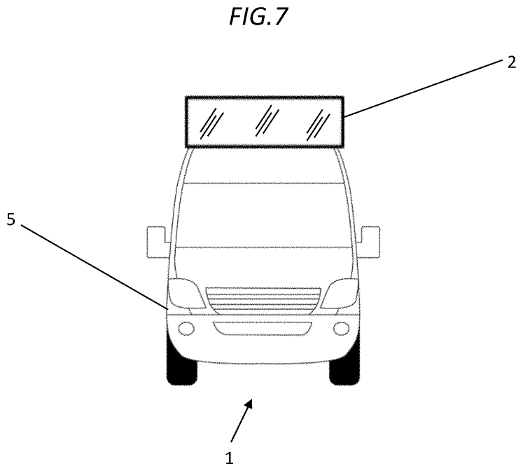

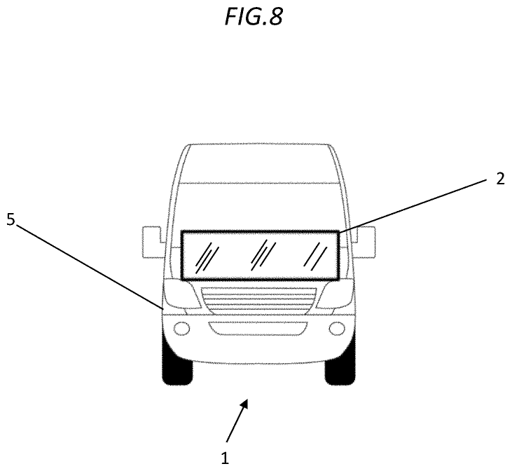

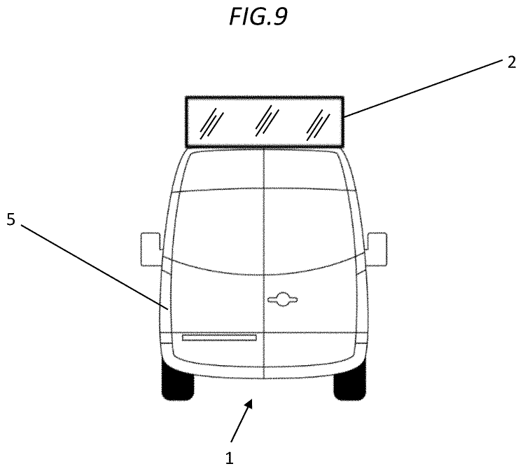

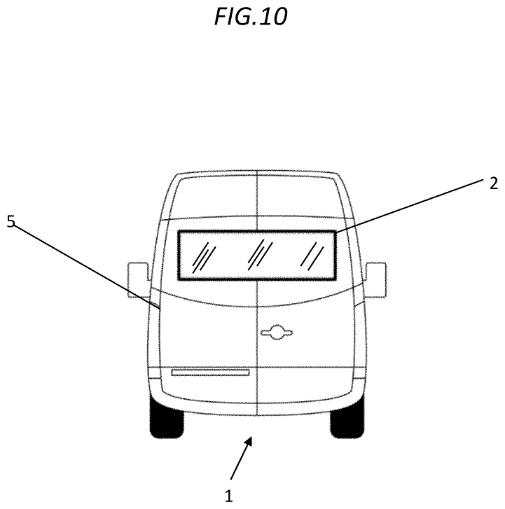

As illustrated in FIGS. 1-11, the subject invention is a system for capturing and analyzing user first-party data received from mobile software devices and autonomous self-driving vehicles 1 with intelligent sensors. The user first-party data is used to display direct contact digital content on self-driving vehicles 1 displaying external digital content platforms, such as large video signage 2, that can be used to display ever-changing digital content.

In the subject invention, a user downloads and engages a mobile software application to order or reserve service from an autonomous self-driving vehicle 1. Before and during ordering of the autonomous self-driving vehicle 1, the mobile software application collects first party data from the user on their mobile device through the mobile software application. Once the autonomous self-driving vehicle 1 is ordered, mobile software application communicates first party data of the user to the self-driving vehicle 1.

When in close proximity to the user the autonomous self-driving vehicle 1 will recognize the user's mobile device through user identification on the mobile software application, verifying the user's mobile device and pairing the mobile device and the self-driving vehicle 1 together. The autonomous self-driving vehicles 1, as it approaches the user, will use the first-party data connection with the mobile software application to display direct content or ad delivery from the collected first-party data of the user on the large video signage 2. After the pairing between the self-driving vehicle 1 and the user's mobile device, the content or ad display connected to the autonomous self-driving vehicle 1 will recognize how long the user viewed the targeted content or ad for and satisfaction of the ad using mood and emotion, human, and body detection. The system contains greater security and less privacy concerns, surrounding usage of the user's data because usage rights are obtained through a user agreement within the mobile software application used to request the autonomous self-driving vehicle 1.

### Example 1

A user downloads and opens a ride-service mobile software application on their mobile device to creates a verified user profile within the ride-service mobile software application. The user orders a ride from an autonomous self-driving vehicle 1 using the ride-service mobile software application. The user arrives in close proximity of the autonomous self-driving vehicle 1 which connects to and verifies the user's mobile device. The user's data of behaviors, actions, or interests demonstrated across the mobile software application allows the self-driving vehicle 1 to use this first party data to personalize the content displayed on the digital screens on the autonomous self-driving vehicle 1. Once the ads are displayed, the autonomous self-driving vehicle 1 will recognize how long the user viewed the targeted ad, and the user's satisfaction level using intelligent sensors.

### Example 2

A user downloads and opens a delivery service mobile software application on their mobile device to creates a verified user profile within the delivery service mobile software application. The user orders a delivery from an autonomous self-driving delivery vehicle using the delivery service mobile software application. The user arrives in close proximity of the autonomous self-driving delivery vehicle which connects to and verifies the user's mobile device. The user's data of behaviors, actions, or interests demonstrated across the delivery service mobile software application allows the self-driving delivery vehicle to use this first party data to personalize the content displayed on the digital screens on the autonomous self-driving delivery vehicle. Once the ads are displayed, the autonomous self-driving delivery vehicle will recognize how long the user viewed the targeted ad, and the user's satisfaction level using intelligent sensors.

In variations of the subject invention, the first party data may include, but it not limited to user behaviors, user actions, user interests, CRM data, subscription data, ordering data, social media data, completed surveys, and user feedback.

The audiences of such digital content include those individuals 7 in proximity to the autonomous vehicle 1 as it traverses a geographic area. Each vehicle 1 contains a plurality of cameras 8 with human recognition software to analyze captured 9 images of individuals 7 and vehicles in close proximity to the vehicle 1. Based on the human recognition, age, gender, the software interface program may alter displayed digital content in real time. These human recognition cameras 8 calculate the number of audience exposures to a given advertisement on the video signage 2, to generate advertisement impression metrics. A large fleet of such vehicles 1 constantly moves on pre-programmed routes between targeted areas, including suburban neighborhoods, to reach a maximum audience, without the need of a human operator.

The invention includes a software program that interfaces with the plurality of self-driving vehicles 1, for monitoring and controlling the vehicles 1 and the digital content platform. The software includes real time tracking of all vehicles 1. The software can configure a digital content campaign for display on the digital content platforms on each vehicle 1 for certain geographic areas, defined times, and frequency of displayed digital content.

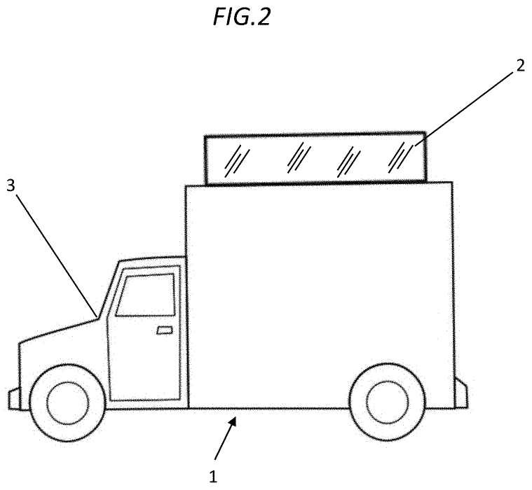

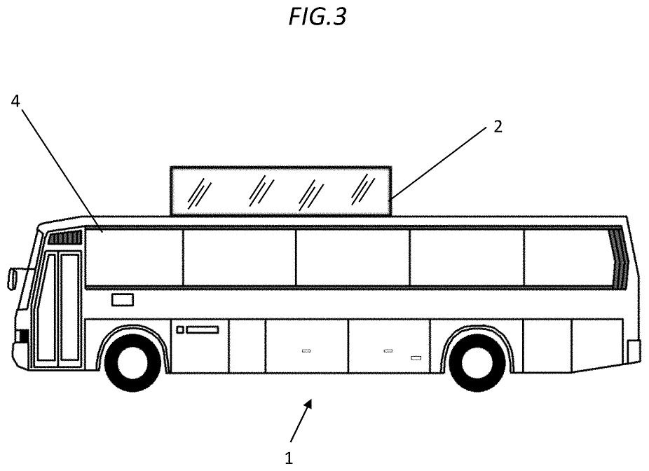

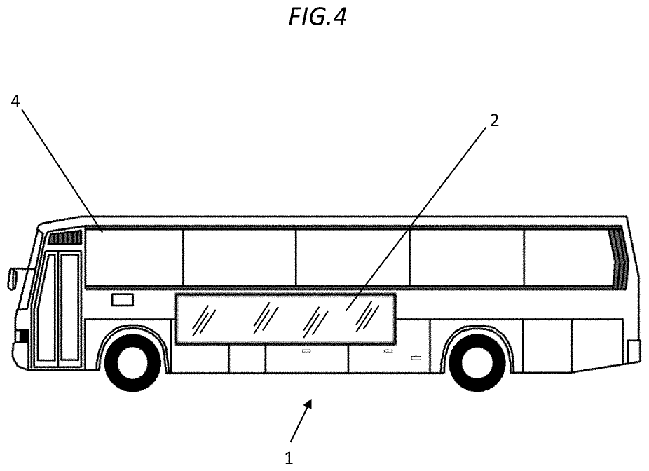

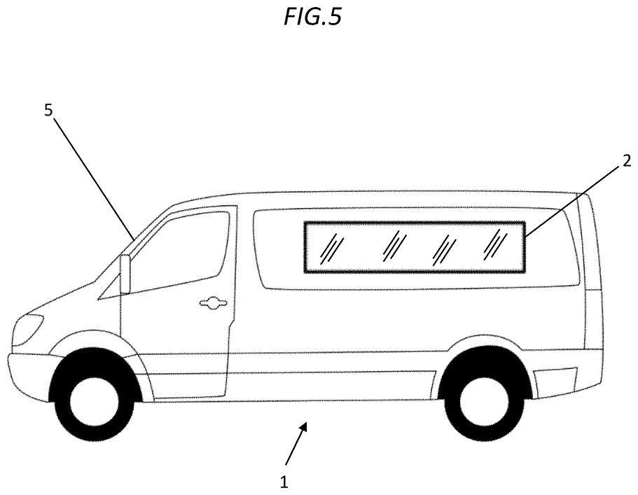

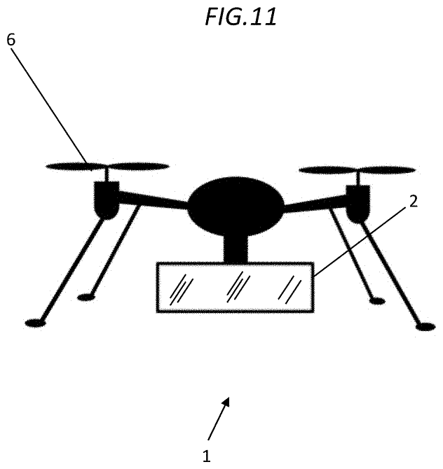

In embodiments of the subject invention, the self-driving vehicle 1 can be any land wheeled vehicle or drone, such as a delivery truck 3, illustrated in FIGS. 1 and 2; a city bus 4, as illustrated in FIGS. 3 and 4, a delivery van 5, as illustrated in FIGS. 5-10, or an aerial drone 6, as illustrated in FIG. 11.

In further embodiments of the subject invention, the vehicle 1 contains a plurality of sensors capture and/or analyze the surrounding environment to permit the vehicle 1 to navigate. The environmental sensors may include, but is not limited to: global positioning system (GPS), satellite receivers, wireless transmitters/receivers, radio transmitters/receivers, RADAR systems, infrared sensors, ultrasound sensors, laser distance finders, accelerometers, inertial measurement units, gyroscopes, compasses, motions sensors, and a plurality of cameras. In further embodiments of the subject invention, the vehicle 1 may contain a plurality of sensors to monitor internal systems, including, but not limited to: engine monitors, fuel gauges, oil levels, oil temperature, tire pressure, and external lights.

In additional embodiments of the subject invention, the software program interfaces with the vehicle's computer control system, the plurality of vehicle sensors, and the vehicle digital content platforms via a communications satellite such as a GPS, a geostationary (GEO) satellite, medium earth orbit (MEO) satellite, or low earth orbit (LEO) satellite, or via a terrestrial wireless network. The wireless network can be a cellular network, such as 3G cellular communication, such as CDMA, EVDO, GSM/GPRS, or 4G cellular communication, such as WiMAX or LTE. The wireless network can be a Wi-Fi or other short range radio network, such as or Bluetooth®. The real time location and activity of each self-driving vehicle 1 may be tracked with a Global Navigation Satellite System (GNSS) such as GPS.

In other embodiments of the subject invention, the software platform can collect and analysis the locations, movements, and activity of the self-driving vehicles 1, and analysis the efficiency of digital content displayed on the video signage 2 to generate optimal routes for certain digital content campaigns. For examples, certain digital content displayed at certain times, and/or certain locations may product higher customer contact and sales with the advertiser. By analyzing this data, the routes of the vehicles 1 and the video displays 2 can be coordinated to display to broad and targeted audiences.

In further embodiments of the subject invention, the plurality of cameras 8 around the self-driving vehicle 1 may capture 9 a plurality of images of the environment of the vehicle, and people 7 around the vehicle. The camera 8 may take images or video. The cameras 8 may be multidirectional cameras, cameras with a 360 degree view, rotating cameras, or stereo optic cameras. In embodiments of the subject invention, the plurality of cameras 8 are coupled to the vehicle's vision system which analyzes captured images in order to identify objects in the environment of autonomous neighborhood vehicle that could include traffic signals, traffic signs, other vehicles 1, pedestrians, bicycles, animals, road boundaries, and any other obstacles.

In embodiments of the subject invention, the self-driving vehicles 1 may contain adaptive motion sensors to determine movement of and around the vehicle 1.

In further embodiments of the subject invention, the vehicle's propulsion system can be an engine connected to a transmission and wheels. The engine could be any combination of an internal combustion engine, an electric motor, a hybrid electric/gas engine, a steam engine, a solar powered engine, or other types of engines. The energy source for the engine self-driving vehicle includes, but is not limited to: gasoline, diesel, petroleum-based fuels, propane, compressed gas-based fuels, ethanol, solar panels, and batteries.

The software program that interfaces with the plurality of self-driving vehicles 1 may run on multiple host servers; local, regional and national databases residing within the host servers. The host servers would contain means for uploading data from the plurality of self-driving vehicles 1; means for organizing all the uploaded data into the local, regional and national databases; means for running specific search queries from the self-driving vehicles 1 on the databases.

The computer control system of the self-driving vehicles 1 may contain a processor, a memory storage, and control software, all communicatively coupled with the plurality of environmental sensors, internal monitoring sensors, the digital content platform, and the external software program that interfaces with the plurality of self-driving vehicles 1. The computer control system of the self-driving vehicles 1 may also be communicatively coupled with components to control vehicle driving, including, but not limited to: acceleration unit, braking unit, steering unit, a vision system, a temperature control unit, an obstacle avoidance system, and a navigation system.

The host servers and the computer control systems for the vehicles 1 may include communication devices (such as a bus), a CPU/processor, a main operating memory, and a storage memory, both communicatively coupled with the plurality of environmental sensors, internal monitoring sensors, the digital content platform, and the external software program that interfaces with the plurality of self-driving vehicles 1. The host servers and the computer control system of the self-driving vehicles 1 may also be communicatively coupled with components to control vehicle driving, including, but not limited to: acceleration unit, braking unit, steering unit, a vision system, a temperature control unit, an obstacle avoidance system, and a navigation system.

Embodiments of the CPU/processor may include processors, microprocessors, multi-core processors, microcontrollers, system-on-chips, field programmable gate arrays (FPGA), application specific integrated circuits (ASIC), application specific instruction-set processors (ASIP), or graphics processing units (GPU). The host servers and the computer control systems for the vehicles store computer retrievable information and software executable instructions and may include solid state, magnetic, or optical recording mediums. Embodiments of an input terminal of the mobile computing devices may include a keyboard, a mouse, a pen, a microphone combined with voice recognition software, a camera, a multi-point touch screen, a bar code scanner, or a SKU scanner. In embodiments of the subject invention, the underlying architecture of the system may be implemented using one or more computer programs, each of which may execute under the control of an operating system, such as Windows, OS2, DOS, AIX, UNIX, MAC OS, iOS, ChromeOS, Android, and Windows Phone or CE.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for capturing and analyzing first party data of a user for use on an autonomous vehicle digital content platform, the system comprising:
a self-driving vehicle containing a computing processor comprising executable software, wherein the processor is communicatively coupled with a data storage device;
a first plurality of sensors for capturing data from and monitoring the surrounding environment of the self-driving vehicle, wherein the first plurality of sensors is communicatively coupled with the computing processor and the data storage device;
a second plurality of sensors for capturing data from and monitoring the internal drive systems of the self-driving vehicle, wherein the second plurality of sensors is communicatively coupled with the computing processor and the data storage device;
wherein the data captured from the first and second plurality of sensors is received by the computing processor, the executable software controls the driving functions of the self-driving vehicle;
an external video screen for displaying a plurality of digital content, wherein the external video screen is communicatively coupled with the computing processor and the data storage device;
a plurality of intelligent camera sensors for taking images and video along a particular field-of-view around and external to the self-driving vehicle, wherein the plurality of intelligent camera sensors is communicatively coupled with the computing processor and the data storage device;
a mobile software application for download and use on a mobile device by the user, wherein the user orders the self-driving vehicle with the mobile software application, further wherein the mobile software application communicates first party data of the user to the self-driving vehicle;
wherein the computing processor and the executable software calculates which digital content from the plurality of digital content to display on the external video screen based on the first party data of the user, wherein the computing processor and the executable software generates a plurality of digital content impressions from the plurality of digital content once the self-driving vehicle is proximate to the user.

2. The system claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time.

3. The system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling a plurality of self-driving vehicles and external video screens in separate geographic locations in real time.

4. The system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring the generated plurality of digital content impressions in real time.

5. The system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring generated pluralities of digital content impressions from a plurality of self-driving road vehicles in separate geographic locations in real time.

6. The system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time, wherein the control server software can configure the digital content displayed on the external video screen in real-time based on the geographic location of the self-driving vehicle.

7. The system of claim 1; wherein the self-driving vehicle comprises a land wheeled vehicle selected from the group consisting of: carts, all-terrain vehicles, cars, trucks, platform trucks, flatbed trucks, semi-trailer trucks, buses, minivans, cargo vans, and panel vans.

8. The system of claim 1, wherein the self-driving vehicle is an aerial drone.

9. A method for capturing and analyzing first party data of a user for use on an autonomous vehicle digital content platform:
(a) downloading a mobile software application on a mobile device by the user;
(b) collecting first party data of the user on the mobile device through the mobile software application;
(c) ordering a self-driving vehicle with the mobile software application, wherein the mobile software application communicates first party data of the user to the self-driving vehicle;
(d) calculating the route from the self-driving vehicle to the user;
(e) generating instructions for the self-driving vehicle to follow directions to the user, wherein the self driving vehicle comprises a computing processor comprising executable software for receiving said instructions, wherein the processor is communicatively coupled with a data storage device;
(f) capturing data from and monitoring the surrounding environment of the self-driving vehicle as it progresses to the user from a first plurality of sensors, wherein the first plurality of sensors is communicatively coupled with the computing processor and the data storage device;
(g) capturing data from and monitoring the internal drive systems of the self-driving vehicle as it progresses towards the user from a second plurality of sensors, wherein the second plurality of sensors is communicatively coupled with the computing processor and the data storage device;
(h) controlling the driving functions of the self-driving vehicle with the data captured from the first and second plurality of sensors received by the computing processor;
(i) displaying a plurality of digital content on an external video screen, wherein the external video screen is communicatively coupled with the computing processor and the data storage device;
(j) capturing radiation reflected from objects along a particular field-of-view around and external to the self-driving vehicle with a plurality of intelligent radiation sensors, wherein the plurality of intelligent radiation sensors is communicatively coupled with the computing processor and the data storage device;
(k) identifying the user from the reflected radiation in the particular field-of-view around and external to the self-driving vehicle from the data captured from the plurality of intelligent radiation sensors on the computing processor;
(l) calculating which digital content from the plurality of digital content to display on the external video screen based on the first party data of the user; and
(m) generating a plurality of digital content impressions from the plurality of digital content once the self-driving vehicle is proximate to the user.

10. The method of claim 9, further comprising sending and receiving data files between a communication circuitry in the self-driving vehicle and a remote control server; and controlling the self-driving vehicle and the external video screen in real time with the remote control server.

11. The method of claim 9, further comprising sending and receiving data files between a communication circuitry in the self-driving vehicle and a remote control server; and controlling a plurality of self-driving vehicles and external video screens in separate geographic locations in real time with the remote control server.

12. The method of claim 9, further comprising sending and receiving data files between a communication circuitry in the self-driving vehicle and a remote control server; and tracking the generated plurality of digital content impressions in real time with the remote control server.

13. The method of claim 9, further comprising sending and receiving data files between a communication circuitry in the self-driving vehicle and a remote control server; and generated pluralities of digital content impressions from a plurality of self-driving road vehicles in separate geographic locations in real time with the remote control server.

14. The method of claim 9, further comprising sending and receiving data files between a communication circuitry in the self-driving vehicle and a remote control server; controlling the self-driving vehicle and the external video screen in real time with the remote control server; and configuring the digital content displayed on the external video screen in real-time based on the geographic location of the self-driving vehicle with the control server.

15. The method of claim 9, wherein the self-driving vehicle comprises a land wheeled vehicle selected from the group consisting of: carts, all-terrain vehicles, cars, trucks, platform trucks, flatbed trucks, semi-trailer trucks, buses, minivans, cargo vans, and panel vans.

16. The method of claim 9, wherein the self-driving vehicle is an aerial drone.
